(19) United States
(12) Patent Application Publication
(10) Pub. No.: US 2014/0028909 A1
(43) Pub. Date: Jan. 30, 2014

(54) METHOD FOR CONVERTING FRAME RATE AND VIDEO PROCESSING APPARATUS USING THE SAME

(71) Applicant: Panasonic Corporation, Osaka (JP)

(72) Inventors: Satoru TANIGAWA, Hyogo (JP); Yoshihiro KISHIMOTO, Osaka (JP)

(73) Assignee: PANASONIC CORPORATION, Osaka (JP)

(21) Appl. No.: 14/042,668

(22) Filed: Sep. 30, 2013

Related U.S. Application Data
(63) Continuation of application No. PCT/JP2012/000301, filed on Jan. 19, 2012.

(30) Foreign Application Priority Data
Apr. 5, 2011 (JP) 2011-083308

(51) Int. Cl. H04N 7/01

(52) U.S. Cl. CPC H04N 7/0127
USPC 348/441

(57) ABSTRACT

A method for converting the frame rate of a video signal includes a film footage detection step of detecting a M:N (M and N are integers) pulldown video signal from an input video signal; a frame rate conversion step of performing frame rate conversion for a series of frames of the input video signal; and a switching control step of, if the M:N pulldown video signal is detected based on a detection result obtained at the film footage detection step, switching, at the frame rate conversion step, the frame rate conversion for the series of frames to frame rate conversion for M:N pulldown, and controlling the switching at a frame in which there is no difference between time required for the frame rate conversion for the series of frames and time required for the frame rate conversion for M:N pulldown.

### CROSS-REFERENCE TO RELATED APPLICATIONS

This is a continuation of International Application No. PCT/JP2012/000301 filed on Jan. 19, 2012, which claims priority to Japanese Patent Application No. 2011-083308 filed on Apr. 5, 2011. The entire disclosures of these applications are incorporated by reference herein.

### BACKGROUND

The present disclosure relates to a frame rate conversion method in which conversion of a frame rate to be used for, e.g., display apparatuses or video processing apparatuses and judder compensation for a pulldown signal are performed, and to a video processing apparatus using the frame rate conversion method.

With an increase in screen size and resolution, emphasis has been recently placed on display of a higher quality video picture on a television set using, e.g., a liquid crystal display device or a plasma display device. In order to smoothly display movement of an object(s) of a video picture on a screen, emphasis has been also placed on video processing for converting a frame rate. Increasing importance has been attached to the following frame rate conversion apparatus and method. A film footage or a video picture generated at 24 fps is converted into a film-originated signal by 2:3 pulldown, or an input video picture is converted into a video signal by 2:2 pulldown. Such an interlaced video signal converted by the foregoing pulldown is converted into a progressive signal to generate progressive scan frames. As a result, movement of a video picture corresponding to the video signal converted by the foregoing pulldown can be smoothly displayed, and the frame rate of the video picture can be converted into the frame rate of a display apparatus. Moreover, the frame rate conversion apparatus and method become increasingly compatible with various pulldown video signals. In the case of a pulldown signal having the high number of a plurality of frames (hereinafter referred to as “repeat frames”) containing the same image, it is expected that a difference in processing time (hereinafter referred to as a “delay time”) between two frames containing different image signals is greater than a difference in processing time between two frames containing a series of image signals, and therefore the processing time should be taken into consideration. As described in, e.g., Japanese Patent Publication No. 2005-208613 (see FIG. 1), a conventional frame rate conversion apparatus includes a plurality of frame rate converters to which different delay times are assigned and which are each configured to perform frame rate conversion in which the number of images corresponding to an input video signal is, in a unit of time, renewed to a different number and the renewed video signal is output, a first selector configured to select one of the video signals output from the frame rate converters and output the selected video signal, and an audio signal delayer configured to delay an audio signal. The audio signal delayer delays the audio signal depending on the delay time assigned to the frame rate converter outputting the video signal selected by the first selector.

### SUMMARY

However, in the conventional frame rate conversion apparatus, if, e.g., a 2:2 pulldown video picture generated at 60 fps and corresponding to a video signal changing every two frames is input, and frame rate conversion is performed with a delay by one frame, the input video signal containing image signals A, A, B, B . . . is, referring to FIG. 5, read as first and second read signals. Of first four frames of the first read signal, two frames contain the same image signal as that contained in corresponding two frames of the second read signal, and therefore a motion vector for such frames is “0.” Thus, no interpolation frame is generated. On the other hand, an interpolation frame is generated by using the motion vector between frames of the first and second read signals having different image signals. Thus, smooth movement of a video picture cannot be realized between frames containing a series of image signal. For such a reason, a film footage detection circuit configured to detect a 2:2 pulldown signal with repetition of two frames is added. If the 2:2 pulldown signal is detected, the second read signal is, referring to FIG. 6, read with the input video signal being further delayed by one frame, and interpolation frames are generated depending on the motion vector.

The case where it is detected that a 2:2 pulldown video picture is input and the processing is switched to frame rate conversion corresponding to 2:2 pulldown will be described with reference to FIGS. 7A-7E. FIG. 7A illustrates that a video signal changing every two frames is input, and FIG. 7B illustrates an output video signal for which frame rate conversion illustrated in FIG. 5 is performed. Moreover, FIG. 7C illustrates an output video signal for which frame rate conversion is performed and then 2:2 pulldown illustrated in FIG. 6 is performed. FIG. 7D illustrates that 2:2 pulldown is detected at an Nth frame and switching is performed from FIG. 7B to FIG. 7C. FIG. 7E illustrates that 2:2 pulldown is detected at an N+1th frame and switching is performed from FIG. 7B to FIG. 7C. In a video picture, such as a 2:2 pulldown video picture, with the lower number of repeat frames, even if switching is performed at the N+1th frame, reversing or forwarding of the video picture does not occur. Although there is still the delay time between frames even by switching, it is not considered as a major issue. Referring to, e.g., FIGS. 8A-8F, for an input video signal containing image signals A, A, A, A, B, B, B, B, first and second read signals are read. Of eight frames of the first read signal, six frames contains the same image signal as that contained in corresponding six frames of the second read signal. Thus, the motion vector is “0” for such frames, and no interpolation frame is generated. On the other hand, an interpolation frame is generated by using the motion vector between frames of the first and second read signals having different image signals. Thus, smooth movement of a video picture cannot be realized. For such a reason, a film footage detection circuit configured to detect repetition of four frames is newly added. The case where 4:4 pulldown is detected and the processing is switched to frame rate conversion corresponding to 4:4 pulldown will be described with reference to FIGS. 8A-8F. FIG. 8A illustrates that a video picture changing every four frames, and FIG. 8B illustrates an output video signal for which the frame rate of consecutive frames is converted. Moreover, FIG. 8C illustrates an output video signal for which 4:4 pulldown is performed and then frame rate conversion is performed. FIG. 8D illustrates that 4:4 pulldown is detected at an N+1th frame and switching is performed from FIG. 8B to FIG. 8C, and FIG. 8E illustrates that 4:4 pulldown is detected at an N+2th frame and switching is performed from FIG. 8B to FIG. 8C. Moreover, FIG. 8F illustrates that 4:4 pulldown is detected at an N+3th frame and switching is performed from FIG. 8B to FIG. 8C. In a video picture, such as a 4:4 pulldown video picture, with the high number of repeat frames, if switching is performed at the N+1th frame, the N+2th frame, or the N+3th frame, the following disadvantage is caused. Reversing of video data occurs, resulting in unnatural movement of an object(s) at the switching point. Thus, continuity of object movement is not maintained, and reversing becomes noticeable. The more the number of repeat frames, the longer the processing time is in frame rate conversion. For such a reason, there is a disadvantage that, e.g., delay adjustment of an audio signal is required.

For a pulldown signal with the high number of repeat frames, in the case where a displayed object(s) moves in only part of a screen, the following disadvantages are caused as compared to the case where a displayed object(s) moves across the entirety of a screen: persistence of vision is increased due to frame rate conversion; and, if an error occurs in motion vector prediction, the error is noticeable due to the high number of repeat frames.

In view of the foregoing, the present disclosure is intended to provide, in the case where frame rate conversion is performed for an input pulldown video picture with the high number of repeat frames, a frame rate conversion method in which continuity of the video picture is ensured without reversing or forwarding of a moving object(s) at a switching point at which processing for a series of frames is switched to processing corresponding to pulldown. Moreover, the present disclosure is applicable to more types of pulldown video signals by employing pulldown to various numbers of repeat frames. Further, the present disclosure is intended to provide a video processing apparatus in which the frame rate conversion method is used to convert the frame rate of a display apparatus or the video processing apparatus and therefore continuity of a video picture is ensured without reversing or forwarding of a moving object(s) at a switching point at which processing for a series of frames is switched to processing for pulldown.

Further, the present disclosure is intended to reduce persistence of vision or make an error in motion vector prediction to be less noticeable in such a manner that frame rate conversion processing is switched between the case where a displayed object(s) moves across the entirety of a screen and the case where a displayed object(s) moves in only part of a screen.

In order to solve the foregoing disadvantages, a frame rate conversion method of a first aspect of the invention includes a film footage detection step of detecting a M:N pulldown video signal from an input video signal, M and N being integers; a frame rate conversion step of performing frame rate conversion for a series of frames of the input video signal; and a switching control step of, if the M:N pulldown video signal is detected based on a detection result obtained at the film footage detection step, switching, at the frame rate conversion step, the frame rate conversion for the series of frames of the video signal to frame rate conversion for the M:N pulldown video signal, and controlling the switching at a frame in which there is no difference between time required for the frame rate conversion for the series of frames of the video signal and time required for the frame rate conversion for the M:N pulldown video signal.

A second aspect of the invention is intended for the method of the first aspect of the invention, in which, at the switching control step, the switching to the frame rate conversion for the M:N pulldown is performed based on predetermined phase information indicating a frame phase of the M:N pulldown video signal.

A third aspect of the invention is intended for the method of the first aspect of the invention, in which, at the switching control step, the switching to the frame rate conversion for the M:N pulldown is performed based on the number of detections of the M:N pulldown video signal.

A fourth aspect of the invention is intended for the method of the first aspect of the invention, in which the film footage detection step includes an integration step of accumulating a frame difference value for one frame period, a comparison step of comparing an integral value obtained by accumulating the frame difference value for one frame period with a predetermined threshold value, a film footage determination step of determining, based on an output result of the comparison step, whether or not there is a frame difference value, and determining whether or not the M:N pulldown video signal is input, and a phase extraction step of outputting phase information of the M:N pulldown video signal based on the output result of the comparison step and a film footage determination result, and the M:N pulldown video signal is detected at the film footage detection step.

A fifth aspect of the invention is intended for the method of the first aspect of the invention, in which the film footage detection step includes a first integration step of accumulating a first frame difference value for one frame period, a first comparison step of comparing an integral value obtained by accumulating the first frame difference value for one frame period with a predetermined threshold value, a second integration step of accumulating a second frame difference value for one frame period, a second comparison step of comparing an integral value obtained by accumulating the second frame difference value for one frame period with a predetermined threshold value, a film footage determination step of determining, based on output results of the first and second comparison steps, whether or not there is a frame difference value, and determining whether or not the M:N pulldown video signal is input, and a phase information output step of outputting phase information of the M:N pulldown video signal based on the output results of the first and second comparison steps and a film footage determination result, and the M:N pulldown video signal is detected at the film footage detection step.

A sixth aspect of the invention is intended for a video processing apparatus including an input processing unit configured to process a signal input from broadcasting or video equipment; a frame rate conversion unit configured to convert a frame rate of a video signal output from the input processing unit; and an output processing unit configured to display the video signal having the converted frame rate on a display unit. The frame rate conversion unit includes a film footage detector configured to detect a M:N pulldown video signal from the video signal output from the input processing unit, M and N being integers, a frame rate converter configured to perform frame rate conversion for a series of frames of the video signal, and a switching controller configured to, if the M:N pulldown video signal is detected based on a detection result output from the film footage detector, switch the frame rate conversion for the series of frames of the video signal to frame rate conversion for the M:N pulldown video signal, and control the switching at a frame in which there is no difference between time required for the frame rate conversion for the series of frames of the video signal and time required for the frame rate conversion for the M:N pulldown video signal.

A seventh aspect of the invention is intended for a video processing apparatus including an input processing unit configured to process a signal decoded from a broadcasting signal or a signal reproduced from a storage unit; a frame rate conversion unit configured to convert a frame rate of a video signal output from the input processing unit; and an output processing unit configured to output the video signal having the converted frame rate to an external unit. The frame rate conversion unit includes a film footage detector configured to detect a M:N pulldown video signal from the video signal output from the input processing unit, M and N being integers, a frame rate converter configured to perform frame rate conversion for a series of frames of the video signal, and a switching controller configured to, if the M:N pulldown video signal is detected based on a detection result output from the film footage detector, switch the frame rate conversion for the series of frames of the video signal to frame rate conversion for the M:N pulldown video signal, and control the switching at a frame in which there is no difference between time required for the frame rate conversion for the series of frames of the video signal and time required for the frame rate conversion for the M:N pulldown video signal.

An eighth aspect of the invention is intended for a frame rate conversion method including a film footage detection step of detecting a M:N pulldown video signal from an input video signal, M and N being integers; a scroll detection step of detecting uniform scroll movement displayed across an entire screen from the input video signal; and a frame rate conversion step of performing frame rate conversion. At the frame rate conversion step, if a detection result obtained at the film footage detection step indicates that the M:N pulldown video signal is detected and it is detected that the uniform scroll movement is displayed across the entire screen, the frame rate conversion is switched to frame rate conversion for the M:N pulldown video signal.

A ninth aspect of the invention is intended for a frame rate conversion method including a scroll detection step of detecting uniform scroll movement displayed across an entire screen from an input video signal; a film footage detection step of detecting a M:N pulldown video signal from the input video signal, M and N being integers; and a frame rate conversion step of performing frame rate conversion. At the frame rate conversion step, if the uniform scroll movement across the entire screen is detected and a detection result obtained at the film footage detection step indicates that the M:N pulldown video signal is detected, the frame rate conversion is switched to frame rate conversion for the M:N pulldown video signal.

A tenth aspect of the invention is intended for a frame rate conversion method including a film footage detection step of detecting a M:N pulldown video signal from an input video signal, M and N being integers; a scroll detection step of detecting uniform scroll movement displayed across an entire screen from the input video signal; and a frame rate conversion step of performing frame rate conversion. At the frame rate conversion step, if a detection result obtained at the film footage detection step indicates that the M:N pulldown video signal is detected and the uniform scroll movement across the entire screen is detected, the frame rate conversion is switched to frame rate conversion for the M:N pulldown video signal. If the detection result indicates that the M:N pulldown video signal is detected and the uniform scroll movement across the entire screen is not detected, the frame rate conversion is switched to frame rate conversion for an X:Y pulldown video signal having a smaller integer ratio than M:N.

According to the present disclosure, in the case where frame rate conversion is performed when a pulldown signal having the high number of repeat frames is input, continuity of a video picture can be ensured at a switching point at which the processing is switched from processing for a series of frames to processing for pulldown, and frame rate conversion can be provided without reversing or forwarding of a moving object(s). Moreover, the present disclosure is applicable to more types of pulldown video signals by employing pulldown to various numbers of repeat frames.

The frame rate conversion method of the present disclosure is used to perform frame rate conversion for a display apparatus or a video processing apparatus. Thus, continuity of a video picture can be ensured at a switching point at which the processing is switched from processing for a series of frames to processing for pulldown, and frame rate conversion can be provided without reversing or forwarding of a moving object(s).

Further, in the case where frame rate conversion is performed when a pulldown signal having the high number of repeat frames is input, since continuity of a video picture can be ensured at a switching point at which the processing is switched from processing for a series of frames to processing for pulldown, an influence of a difference in delay of an audio signal can be reduced without switching the delay of the audio signal depending on the type of pulldown.

In the case of a pulldown signal having the high number of repeat frames, a scroll movement, i.e., uniform movement displayed on a screen, is detected, thereby performing frame rate conversion depending on the number of repeat frames during the scroll movement. Thus, persistence of vision due to frame interpolation in the case where a displayed object(s) moves in part of a screen or a small area of the screen can be reduced, and noise due to an error in motion vector prediction can be reduced.

### BRIEF DESCRIPTION OF THE DRAWINGS

FIG. 1 is a block diagram of a frame rate conversion method of a first embodiment of the present disclosure.

FIG. 2 is a block diagram of a film footage detection step in the frame rate conversion method of the first embodiment.

FIG. 3 is a block diagram of another film footage detection step in the frame rate conversion method of the first embodiment.

FIG. 4 is a block diagram of a video processing apparatus of a second embodiment of the present disclosure.

FIG. 5 is a timing chart illustrating video processing in the case where a 2:2 pulldown video signal is input in a conventional frame rate conversion method.

FIG. 6 is a timing chart illustrating film footage processing in the case where a 2:2 pulldown video signal is input in the conventional frame rate conversion method.

FIGS. 7A-7E are diagrams of interpolation frames and illustrate switching in the case where a 2:2 pulldown video signal is input in the conventional frame rate conversion method.

FIGS. 8A-8F are diagrams of interpolation frames and illustrate switching in the case where a 4:4 pulldown video signal is input in the conventional frame rate conversion method.

FIG. 9 is a timing chart illustrating video processing in the case where a 4:4 pulldown video signal is input in the first embodiment of the present disclosure.

FIG. 10 is a timing chart illustrating film footage processing in the case where a 4:4 pulldown video signal is input in the first embodiment of the present disclosure.

FIGS. 11A-11D are diagrams of interpolation frames and illustrate switching in the case where a 4:4 pulldown video signal is input in the first embodiment of the present disclosure.

FIG. 12 is a first flowchart for frame rate conversion of the first embodiment of the present disclosure.

FIG. 13 is a second flowchart for frame rate conversion of the first embodiment of the present disclosure.

FIG. 14 is a third flowchart for frame rate conversion of the first embodiment of the present disclosure.

FIG. 15 is a flowchart for frame rate conversion of a third embodiment of the present disclosure.

### DETAILED DESCRIPTION

Embodiments of the present disclosure will be described below in detail with reference to drawings.

### First Embodiment

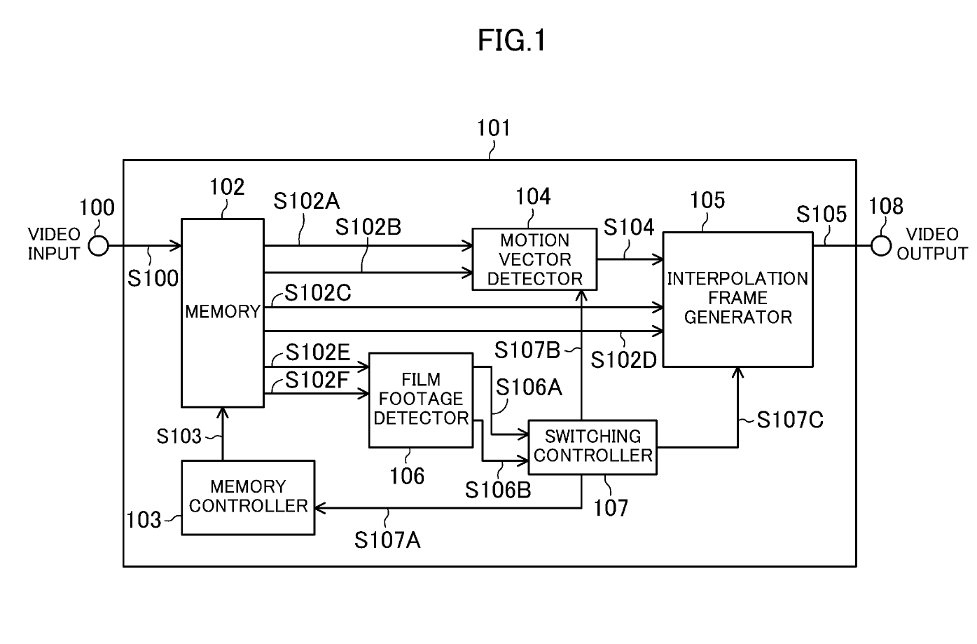

FIG. 1 is a block diagram illustrating a frame rate conversion method of a first embodiment of the present disclosure.

Referring to FIG. 1, a video signal 5100 input from an input unit 100 is input to a frame rate conversion unit 101, and then is input to a storage 102 using a memory. Depending on output of a switching controller 107, a memory controller 103 reads the followings: frame data S102A, S102B required for a motion vector detector 104; frame data S102C, S102D required for an interpolation frame generator 105; and frame data S102E, S102F required for a film footage detector 106. A video signal S105 having a frame rate converted by the interpolation frame generator (frame rate converter) 105 is output from an output unit 108.

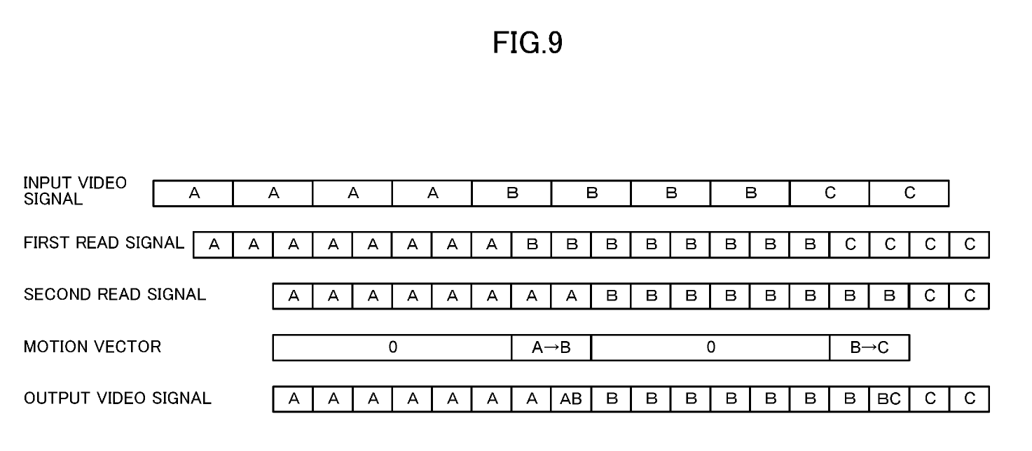

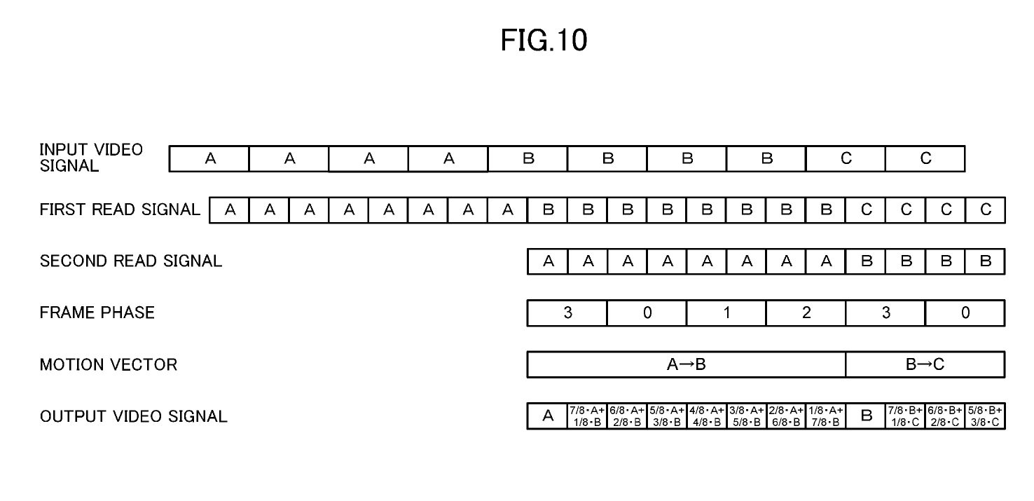

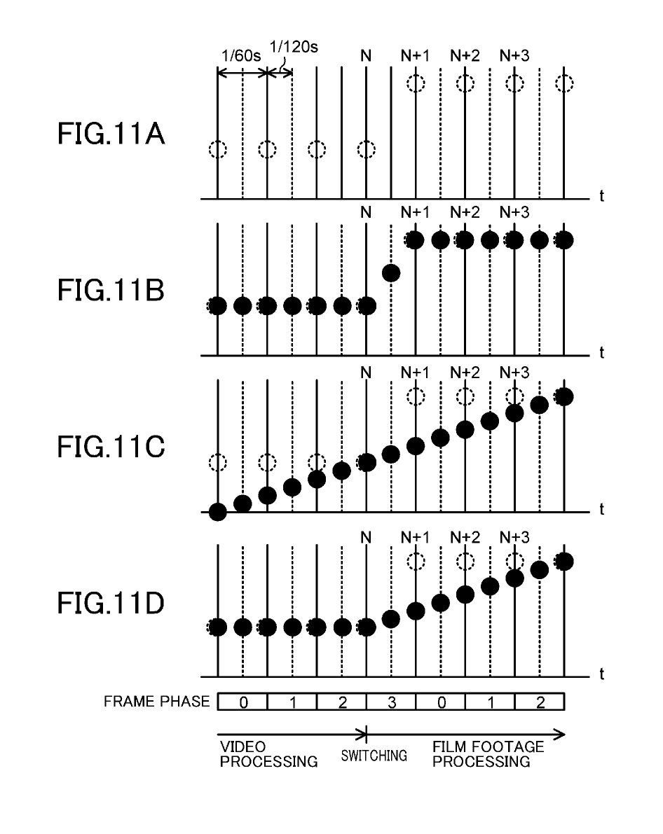

FIG. 9 is a timing chart illustrating video processing in the case where a 4:4 pulldown video signal is input in the first embodiment. FIG. 10 is a timing chart illustrating film footage processing in the case where a 4:4 pulldown video signal is input in the first embodiment. FIGS. 11A-11D are diagrams of interpolation frames, and illustrate switching in the case where a 4:4 pulldown video signal is input in the first embodiment.

An operation of the first embodiment will be described with reference to FIGS. 1, 9, 10, and 11A-11D. For example, a video signal 5100 changing every four frames in a pattern of A, A, A, A, B, B, B, B, . . . is input as illustrated in FIG. 9. A first read signal containing the frame data S102C and a second read signal containing the frame data S102D are read from the storage 102. Comparison between the frame data S102C contained in the first read signal and the frame data S102D contained in the second read signal results as follows. Of first eight frames of the first read signal, six frames contain the same image signals as that contained in corresponding six frames of the second read signal. Thus, a motion vector is “0” during a six-frame period of an output video signal, and no interpolation frame is generated. On the other hand, an interpolation frame is generated by using the motion vector between two frames of the first and second read signals having different image signals. However, since frames having the same image signal are repeated, smooth movement of a video picture corresponding to first eight frames of the output video signal cannot be realized, resulting in juddering of the video picture.

For the foregoing reasons, in the present embodiment, the film footage detector 106 detects, based on the frame data S102E, S102F output from the storage 102, the number of repeat frames and detects whether or not a M:N (“M” and “N” are integers) pulldown signal is input. Then, the film footage detector 106 outputs a detected video pattern signal S106B. If the M:N pulldown video signal is detected, the film footage detector 106 outputs a frame phase signal S106A corresponding to a frame phase per cycle of the pulldown signal. The present embodiment describes one example where a 4:4 pulldown video signal is input. Upon detection of 4:4 pulldown, a signal with a repetition of values 0, 1, 2, 3 is output as the frame phase signal S106A corresponding to the frame phase per cycle. In order to read, based on the frame phase signal S106A and the video pattern signal S106B output from the film footage detector 106, frame data required for each video processing pattern in the switching controller 107, the memory controller 103 is switched to switch frame data to be output to the motion vector detector 104 and the interpolation frame generator 105 based on an output pulldown signal S107A.

FIG. 10 is a timing chart in the case where a 4:4 pulldown video signal is detected. A second read signal containing frame data S102D is, corresponding to pulldown processing, read such that the input video signal is delayed by four frames. Moreover, the switching controller 107 outputs a signal S107B indicating that a video pattern is switched to the motion vector detector 104, and then switching and setting of the motion vector detector 104 are performed. The motion vector detector 104 outputs a motion vector signal S104 indicating motion from the frame containing the image signal A to the frame containing the image signal B. Moreover, the switching controller 107 outputs a signal 107C indicating the video pattern to the interpolation frame generator 105. Upon generation of an interpolation frame(s), switching of the frame interpolation ratio of the motion vector signal S104 and setting of the interpolation frame generator 105 are performed. Frame rate conversion corresponding to the detected video pattern is performed in the interpolation frame generator 105, and a video signal having the converted frame rate is output from the output unit 108.

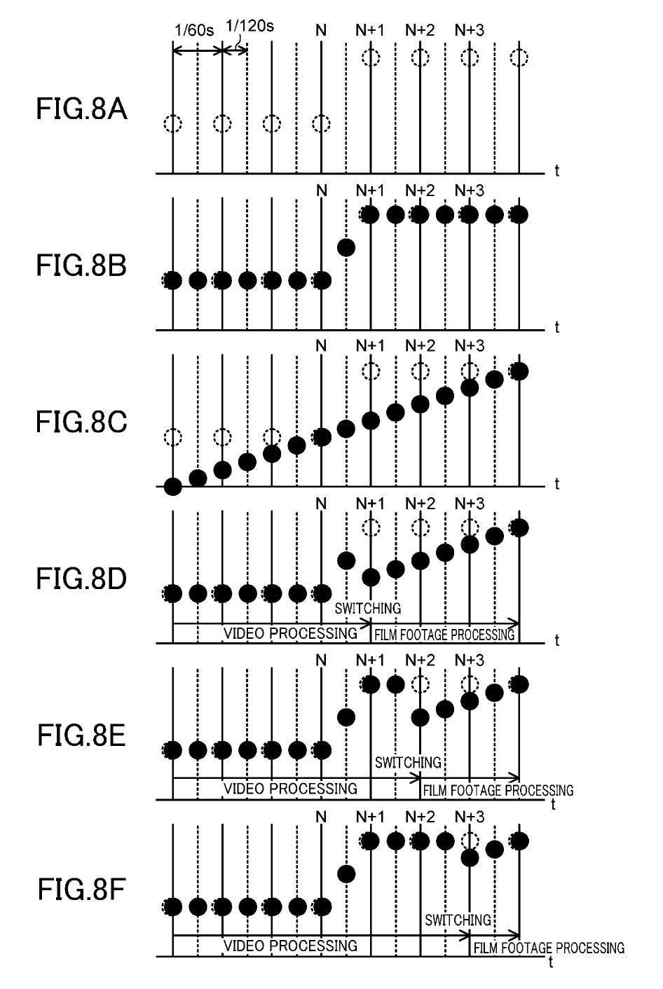

Switching timing in an operation of the switching controller 107 will be described with reference to FIGS. 8A-8F and 11A-11D. In the case of switching at an N+1th frame (see FIG. 8D), switching at an N+2th frame (see FIG. 8E), and switching at an N+3th frame (see FIG. 8F), reversing of video data occurs, resulting in unnatural movement of an object(s) at the switching point. Thus, there is a disadvantage that continuity of object movement is not maintained and reversing becomes noticeable. For such a reason, in the case where image signals indicating a series of movement are input at the Nth, N+1th, N+2th, and N+3th frames, even if the film footage detector 106 determines that a M:N pulldown signal is input at the N+1th, N+2th, and N+3th frames, the processing is not switched to processing for a pulldown video picture. Since the same processing as that at the Nth frame is performed at the frame subsequent to the N+3th frame, the processing is switched only at the Nth frame. Control is performed such that the processing is switched when the frame phase signal S106A having a predetermined value is output from the film footage detector 106. FIG. 11A illustrates a 4:4 pulldown signal changing every four frames is input. FIG. 11B illustrates an output video signal with consecutive frames for which frame rate conversion is performed. FIG. 11C illustrates an output video signal for which 4:4 pulldown is performed and then frame rate conversion is performed. FIG. 11D illustrates that a pulldown signal is detected and switching is performed from FIG. 11B to FIG. 11C at an Nth frame. No switching is performed after detection of a pulldown signal until a frame phase signal having a value of “3” is generated. When a pulldown signal is detected and a frame phase signal having a predetermined value is generated, the processing switched to pulldown processing in frame rate conversion. In the case where the number of repeat frames is “K (an integer),” a value for frame phase signal changes in a pattern of 0, 1, . . . , (K−1), and the predetermined value is generated every K-multiple frames. The predetermined value is a value corresponding to a frame in which a difference in time of movement of an object(s) between frame rate conversion for a series of frames and frame rate conversion for pulldown processing is zero or small. It has been described that switching is performed at the frame phase corresponding to one of the K repeat frames. However, if little impact such as reversing of movement of an object(s) is on a video picture, the processing may be switched at plural points. In the case of a M:N pulldown signal, since the value for frame phase signal changes in a pattern of 0, 1, . . . , (M+N−1), a predetermined value is generated every M+N-multiple frames. The predetermined value is a value corresponding to a frame in which a difference in time of movement of an object(s) between frame rate conversion for a series of frames and frame rate conversion for pulldown processing is zero or small. It has been described that the processing is switched at the frame phase corresponding to one of the (M+N) repeat frames. However, if little impact such as reversing of movement of an object(s) is on a video picture, the processing may be switched at plural points, or a different value for frame phase signal may be, in the case of a M:N pulldown signal, assigned to each repetition of the frame phase values. In the switching controller 107, switching is performed depending on the frame phase. Alternatively, the number of determinations as detecting a pulldown signal may be set. That is, switching may be performed based on a threshold value for the number of determinations which is set at, e.g., multiples of K or multiples of (M+N).

(First Configuration Example of Film Footage Detector)

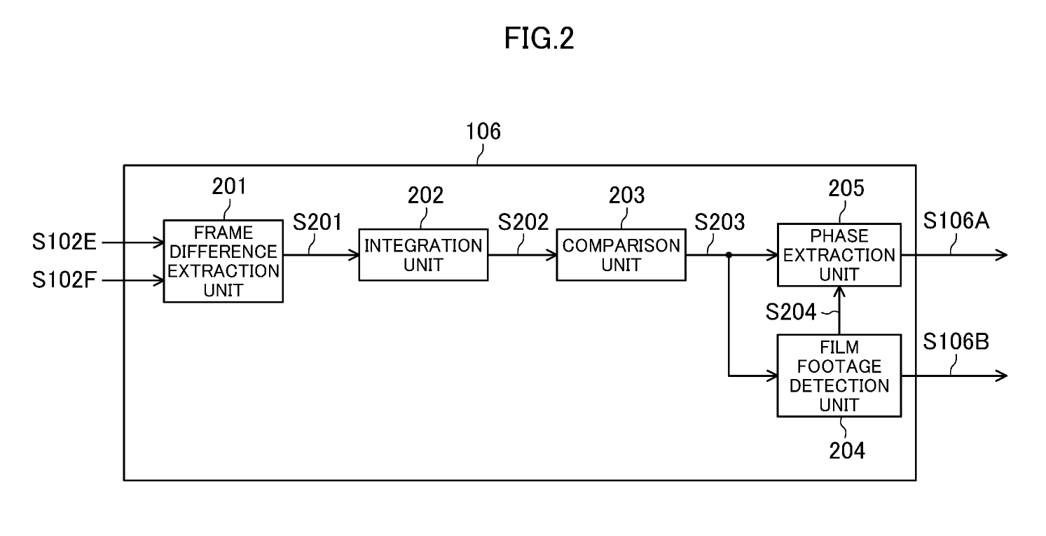

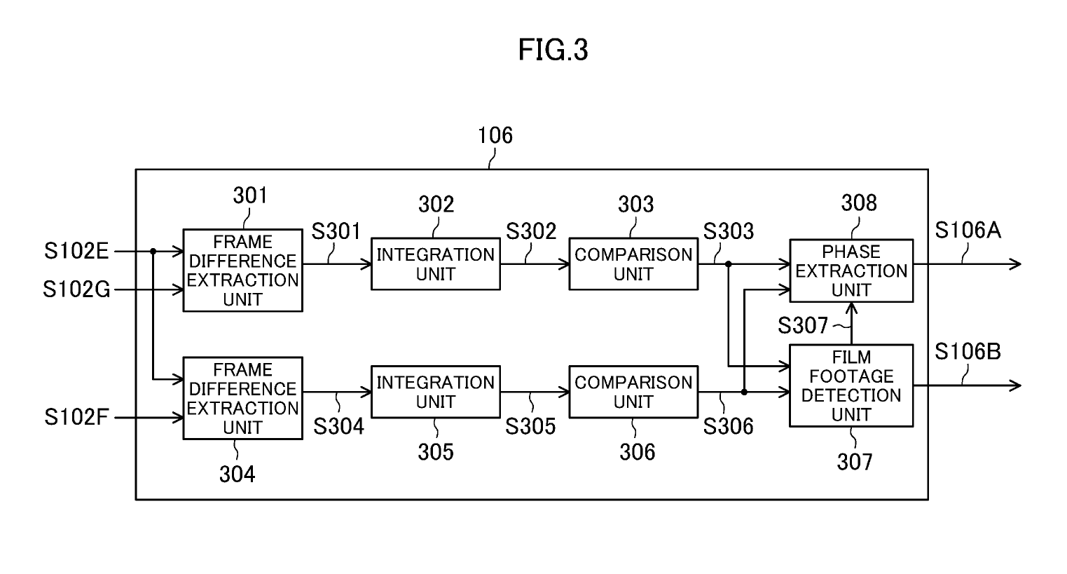

Next, a first configuration example of the film footage detector 106 of the first embodiment will be described with reference to FIGS. 2 and 3.

FIG. 2 is a block diagram illustrating the first configuration example of the film footage detector 106 in the frame rate conversion method of the first embodiment.

Referring to FIG. 2, frame data S102E, S102F read with a frame delay from the storage 102 using the memory is input to a frame difference extraction unit 201, and frame difference values S201 are obtained. The frame difference values S201 are accumulated for one frame period in an integration unit 202, and a cumulative integral value S202 is obtained. Then, the integral value S202 is compared with a threshold value preset in a comparison unit 203. If the integral value S202 is less than the threshold value, a frame correlation signal S203 indicating that a frame of the frame data S102E contains the same data as that contained in a corresponding one of frames of the frame data S102F is output. If the integral value S202 is greater than the threshold value, a frame correlation signal S203 indicating that a frame of the frame data S102E contains different data from that contained in a corresponding one of frames of the frame data S102F is output. In a film footage detection unit 204, the number of repeat frames is determined based on the frame correlation signal S203. Moreover, it is also determined, based on the frame correlation signal S203, whether or not a M:N pulldown signal is input. Meanwhile, in a phase extraction unit 205, a frame phase signal S106A is output based on a determination result S204 and the frame correlation signal S203. For example, if a video picture changing every four frames is input, a frame correlation signal S203 has values of 0, 1, 1, 1 . . . where “0” represents that there is no correlation and “1” represents that there is a correlation. Since the number of repeat frames is determined by the comparison with the preset correlation pattern, video patterns for various pulldown signals and various numbers of repeat frames can be detected.

(Second Configuration Example of Film Footage Detector)

FIG. 3 is a block diagram illustrating a second configuration example of the film footage detector 106 in the frame rate conversion method of the first embodiment.

In addition to frame data S102E, S102F read with frame delay from the storage 102 using the memory, frame data S102G is input as illustrated in FIG. 3. Each of these types of frame data S102E, S102F, S102G is input to both of frame difference extraction units 301, 304, and frame difference values S301, S304 are obtained. The frame difference values S301 are accumulated for one frame period in an integration unit 302, and the frame difference values S304 are accumulated for one frame period in an integration unit 305. As a result, cumulative integral values S302, S305 are obtained. Then, each of the integral values S302, S305 is compared with a corresponding one of threshold values preset in comparison units 303, 306. If the integral value S302, S305 is less than the threshold value, a frame correlation signal S303, S306 indicating that frames of the frame data S102E, S102F, S102G corresponding to each other are the same as each other in data contained therein is output. If the integral value S302, S305 is greater than the threshold value, a frame correlation signal S303, S306 indicating that frames of the frame data S102E, S102F, S102G corresponding to each other are different from each other in data contained therein is output.

In a film footage detection unit 307, the number of repeat frames is determined based on the frame correlation signals S303, 306. Moreover, it is also determined, based on the frame correlation signals S303, 306, whether or not a M:N pulldown signal is input. Meanwhile, in a phase extraction unit 308, a frame phase signal S106A is output based on a determination result S307 and the frame correlation signals S303, S306. Since the number of repeat frames is determined by the comparison with the preset correlation pattern, video patterns for various pulldown signals and various numbers of repeat frames can be detected.

In FIGS. 2 and 3, it has been described that two or three types of frame data are input. However, the present disclosure is not limited to such a configuration. Four or more types of frame data may be processed to detect video patterns for various pulldown signals and various numbers of repeat frames.

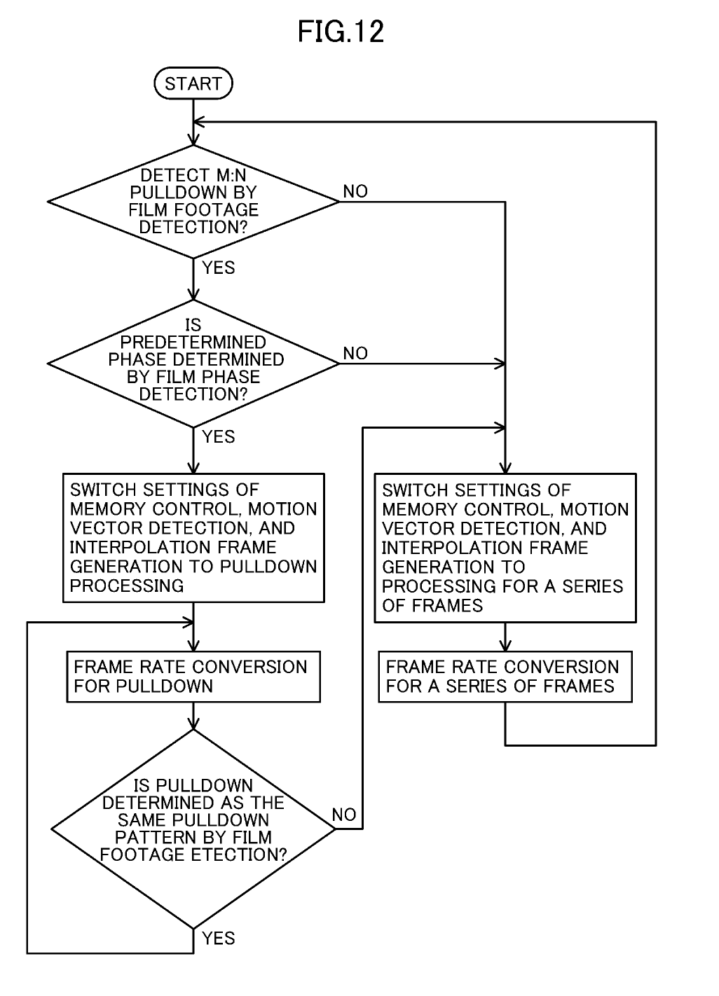

FIG. 12 is a first flowchart for frame rate conversion of the present disclosure, and a process therefor will be described with reference to FIG. 12.

It is determined, by film footage detection, whether or not a video signal corresponding to an input video picture is a M:N pulldown video signal. If the video signal is not the M:N pulldown signal, settings of memory control, motion vector detection, and interpolation frame generation are switched to those corresponding to frame rate conversion for a series of frames, and then such frame rate conversion is performed.

On the other hand, if the video signal is the M:N pulldown video signal, a frame phase is determined, and it is determined whether or not the determined frame phase is a predetermined phase. If the frame phase is not the predetermined phase, the settings of memory control, motion vector detection, and interpolation frame generation are switched to those corresponding to frame rate conversion for a series of frames, and then such frame rate conversion is performed. If the frame phase is the predetermined phase, the settings of memory control, motion vector detection, and interpolation frame generation are switched to those corresponding to M:N pulldown to switch processing for memory control, motion vector detection, and interpolation frame generation. Then, frame rate conversion for M:N pulldown is performed. During frame rate conversion for pulldown processing, film footage detection is performed for each frame. If pulldown video signals are processed in the same pulldown pattern, frame rate conversion for pulldown processing continues. If pulldown video signals are not processed in the same pulldown pattern, the settings of memory control, motion vector detection, and interpolation frame generation are switched to those corresponding to frame rate conversion for a series of frames, and then such frame rate conversion is performed. If frame rate conversion for a series of frames is performed, the process returns to “START” at a subsequent frame, and the process is repeated.

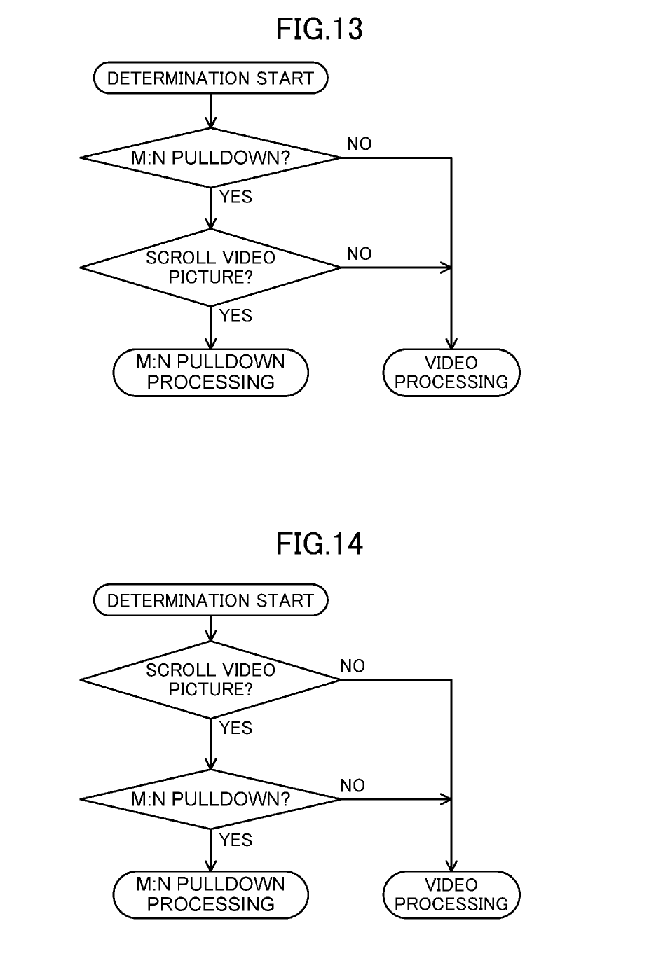

FIG. 13 is a second flowchart for frame rate conversion of the present disclosure, and a process therefor will be described with reference to FIG. 13.

It is determined, by M:N pulldown determination, whether or not a video signal corresponding to an input video picture is a M:N pulldown video signal. If the video signal is not the M:N pulldown signal, settings of memory control, motion vector detection, and interpolation frame generation are switched to those corresponding to frame rate conversion for a series of frames, and then such frame rate conversion is performed.

On the other hand, if the video signal is the M:N pulldown video signal, it is determined, by scroll detection, whether or not the video picture is a scroll video picture in which a displayed object(s) moves in a uniform manner or in the same direction across the entirety of a screen. If the video picture is not the scroll video picture, the settings of memory control, motion vector detection, and interpolation frame generation are switched to those corresponding to frame rate conversion for a series of frames, and then such frame rate conversion is performed. On the other hand, if the video picture is the scroll video picture, the settings of memory control, motion vector detection, and interpolation frame generation are switched to those corresponding to M:N pulldown to switch processing for memory control, motion vector detection, and interpolation frame generation. Then, frame rate conversion for M:N pulldown is performed.

FIG. 14 is a third flowchart for frame rate conversion of the present disclosure, and a process therefor will be described with reference to FIG. 14.

It is determined whether or not an input video picture is a scroll video picture in which a displayed object(s) moves in a uniform manner or in the same direction across the entirety of a screen. If the video picture is not the scroll video picture, settings of memory control, motion vector detection, and interpolation frame generation are switched to those corresponding to frame rate conversion for a series of frames, and then such frame rate conversion is performed. On the other hand, if the video picture is the scroll video picture, it is determined, by M:N pulldown determination, whether or not a video signal corresponding to the input video picture is a M:N pulldown video signal. If the video signal is not the M:N pulldown signal, the settings of memory control, motion vector detection, and interpolation frame generation are switched to those corresponding to frame rate conversion for a series of frames, and then such frame rate conversion is performed. If the video signal is the M:N pulldown signal, the settings of memory control, motion vector detection, and interpolation frame generation are switched to those corresponding to M:N pulldown to switch processing for memory control, motion vector detection, and interpolation frame generation. Then, frame rate conversion for M:N pulldown is performed.

In the foregoing frame rate conversion, the processes of the second and third flowcharts are different from each other in the order of performing M:N pulldown detection and scroll detection. However, M:N pulldown detection and scroll detection may be performed in parallel, and frame rate conversion for M:N pulldown may be performed based on determination results of M:N pulldown detection and scroll detection.

### Second Embodiment

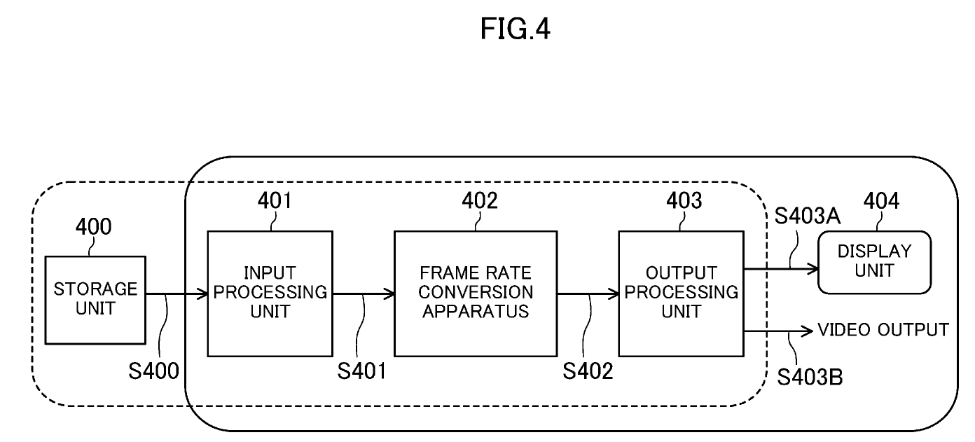

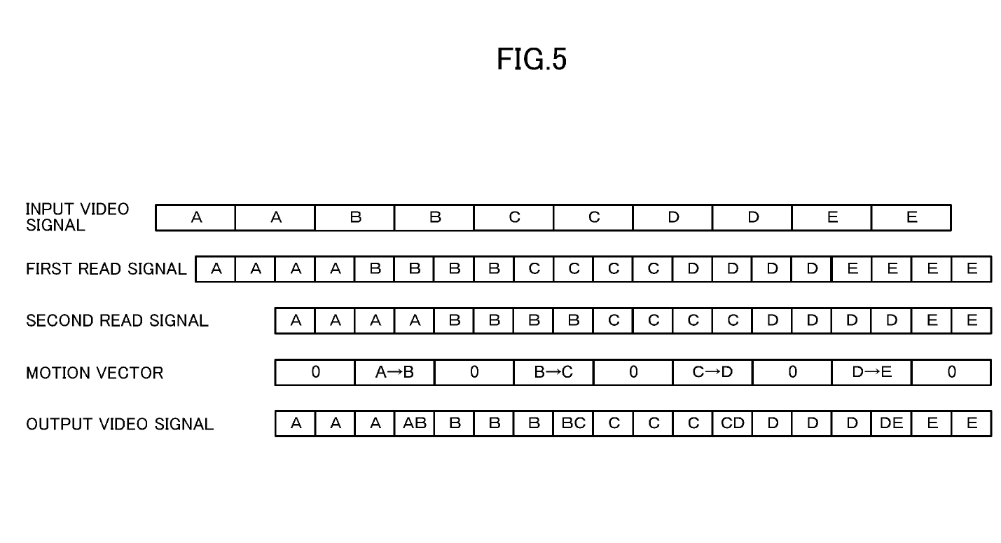

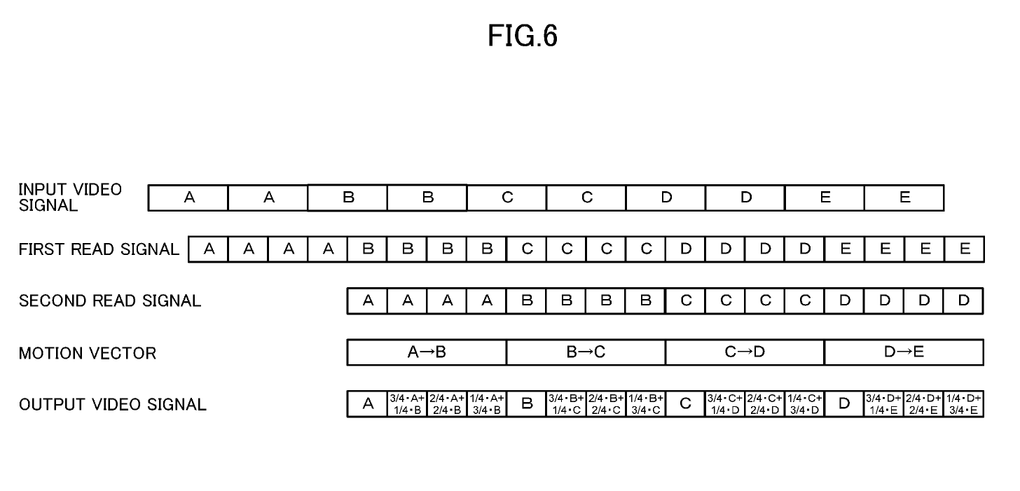

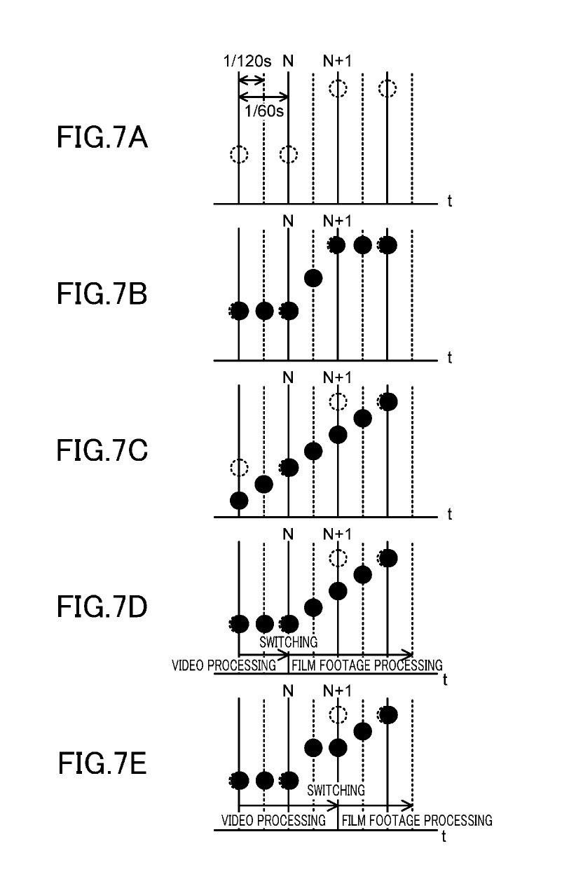

FIG. 4 is a block diagram illustrating a video processing apparatus using a frame rate conversion method in a second embodiment of the present disclosure.

Referring to FIG. 4, a reference numeral “400” represents a storage unit such as DVD discs, Blu-ray discs, or hard discs, a reference numeral “401” represents an input processing unit configured to reproduce video signals recorded from broadcasting or video signals from recording media, a reference numeral “402” represents the frame rate conversion apparatus of the first embodiment, a reference numeral “403” represents an output processing unit configured to output a video signal to an external unit or a display unit, and a reference numeral “404” represents a display unit such as liquid crystal displays or plasma displays.

In the input processing unit 401 configured to process video data generated or recorded in the storage unit 400, a video signal containing a M:N pulldown signal is generated. For example, such a pulldown video signal is converted from a 60 Hz video signal into a 120 Hz video signal by using the frame rate conversion method of the first embodiment. Since the video signal having the converted frame rate is output from the output processing unit 403 to the external unit, such a video signal is processed into such a signal format that the video signal can be output via connection through a cable or via wireless connection. For display of a video picture on the display unit 404, a synchronization signal to be reference for display and a timing signal for controlling a display apparatus are, in addition to a video signal, generated and processed to display the video picture on a screen.

The display unit 404 is required for video processing apparatuses configured to display a video picture on a screen, such as television sets or displays. However, video processing apparatuses, such as DVDs, Blu-ray discs, or hard discs, configured to record and/or reproduction a video picture can be realized with a configuration which does not include the display unit 404, and a video signal having a converted frame rate is output via an output terminal connected to the external unit.

### Third Embodiment

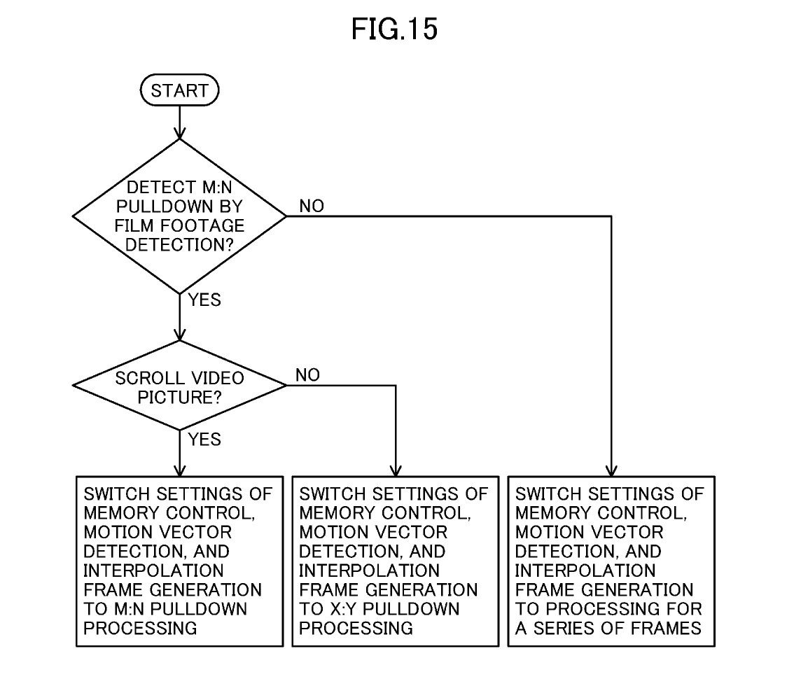

FIG. 15 is a flowchart for a frame rate conversion method of a third embodiment of the present disclosure.

Referring to FIG. 15, it is determined, by film footage detection, whether or not a video signal corresponding to an input video picture is a M:N pulldown video signal. If the video signal is not the M:N pulldown signal, settings of memory control, motion vector detection, and interpolation frame generation are switched to those corresponding to frame rate conversion for a series of frames, and then such frame rate conversion is performed.

On the other hand, if the video signal is the M:N pulldown video signal, it is determined, by scroll detection, whether or not the video picture is a scroll video picture in which a displayed object(s) moves in a uniform manner or in the same direction across the entirety of a screen. If the video picture is not the scroll video picture, the settings of memory control, motion vector detection, and interpolation frame generation are switched to those corresponding to X:Y pulldown to switch processing for memory control, motion vector detection, and interpolation frame generation. Then, frame rate conversion for X:Y pulldown is performed. On the other hand, if the video picture is the scroll video picture, the settings of memory control, motion vector detection, and interpolation frame generation are switched to those corresponding to M:N pulldown to switch processing for memory control, motion vector detection, and interpolation frame generation. Then, frame rate conversion corresponding to M:N pulldown is performed.

Note that M:N and X:Y satisfy relationships of M>X and N>Y. Suppose that M:N pulldown is 8:7 pulldown. In such a case, X:Y pulldown is 3:2 pulldown, and frame rate conversion is switched between frame rate conversion for the lower number of repeat frames and frame rate conversion for the higher number of repeat frames depending on whether or not a displayed object(s) moves in a uniform manner or in the same direction on a screen.

As described above, the frame rate conversion apparatus and method of the present disclosure are useful as apparatus and method for performing frame rate conversion used for, e.g., display apparatuses, video processing apparatuses, or television sets and performing judder compensation for a pulldown video signal.

What is claimed is:

1. A method for converting a frame rate, comprising:
a film footage detection step of detecting a M:N pulldown video signal from an input video signal, M and N being integers;
a frame rate conversion step of performing frame rate conversion for a series of frames of the input video signal; and
a switching control step of, if the M:N pulldown video signal is detected based on a detection result obtained at the film footage detection step,
switching, at the frame rate conversion step, the frame rate conversion for the series of frames of the video signal to frame rate conversion for the M:N pulldown video signal, and
controlling the switching at a frame in which there is no difference between time required for the frame rate conversion for the series of frames of the video signal and time required for the frame rate conversion for the M:N pulldown video signal.

2. The method of claim 1, wherein
at the switching control step, the switching to the frame rate conversion for the M:N pulldown is performed based on predetermined phase information indicating a frame phase of the M:N pulldown video signal.

3. The method of claim 1, wherein
at the switching control step, the switching to the frame rate conversion for the M:N pulldown is performed based on the number of detections of the M:N pulldown video signal.

4. The method of claim 1, wherein
the film footage detection step includes
an integration step of accumulating a frame difference value for one frame period,
a comparison step of comparing an integral value obtained by accumulating the frame difference value for one frame period with a predetermined threshold value,
a film footage determination step of determining, based on an output result of the comparison step, whether or not there is a frame difference value, and determining whether or not the M:N pulldown video signal is input, and
a phase extraction step of outputting phase information of the M:N pulldown video signal based on the output result of the comparison step and a film footage determination result, and
the M:N pulldown video signal is detected at the film footage detection step.

5. The method of claim 1, wherein
the film footage detection step includes
a first integration step of accumulating a first frame difference value for one frame period,
a first comparison step of comparing an integral value obtained by accumulating the first frame difference value for one frame period with a predetermined threshold value,
a second integration step of accumulating a second frame difference value for one frame period,
a second comparison step of comparing an integral value obtained by accumulating the second frame difference value for one frame period with a predetermined threshold value,
a film footage determination step of determining, based on output results of the first and second comparison steps, whether or not there is a frame difference value, and determining whether or not the M:N pulldown video signal is input, and
a phase information output step of outputting phase information of the M:N pulldown video signal based on the output results of the first and second comparison steps and a film footage determination result, and
the M:N pulldown video signal is detected at the film footage detection step.

6. A video processing apparatus comprising:
an input processing unit configured to process a signal input from broadcasting or video equipment;
a frame rate conversion unit configured to convert a frame rate of a video signal output from the input processing unit; and
an output processing unit configured to display the video signal having the converted frame rate on a display unit,
wherein the frame rate conversion unit includes
a film footage detector configured to detect a M:N pulldown video signal from the video signal output from the input processing unit, M and N being integers,
a frame rate converter configured to perform frame rate conversion for a series of frames of the video signal, and
a switching controller configured to, if the M:N pulldown video signal is detected based on a detection result output from the film footage detector,
switch the frame rate conversion for the series of frames of the video signal to frame rate conversion for the M:N pulldown video signal, and
control the switching at a frame in which there is no difference between time required for the frame rate conversion for the series of frames of the video signal and time required for the frame rate conversion for the M:N pulldown video signal.

7. A video processing apparatus comprising:
an input processing unit configured to process a signal decoded from a broadcasting signal or a signal reproduced from a storage unit;
a frame rate conversion unit configured to convert a frame rate of a video signal output from the input processing unit; and
an output processing unit configured to output the video signal having the converted frame rate to an external unit,
wherein the frame rate conversion unit includes
a film footage detector configured to detect a M:N pulldown video signal from the video signal output from the input processing unit, M and N being integers,
a frame rate converter configured to perform frame rate conversion for a series of frames of the video signal, and
a switching controller configured to, if the M:N pulldown video signal is detected based on a detection result output from the film footage detector,
switch the frame rate conversion for the series of frames of the video signal to frame rate conversion for the M:N pulldown video signal, and
control the switching at a frame in which there is no difference between time required for the frame rate conversion for the series of frames of the video signal and time required for the frame rate conversion for the M:N pulldown video signal.

8. A method for converting a frame rate, comprising:
a film footage detection step of detecting a M:N pulldown video signal from an input video signal, M and N being integers;
a scroll detection step of detecting uniform scroll movement displayed across an entire screen from the input video signal; and
a frame rate conversion step of performing frame rate conversion,
wherein, at the frame rate conversion step, if a detection result obtained at the film footage detection step indicates that the M:N pulldown video signal is detected and it is detected that the uniform scroll movement is displayed across the entire screen, the frame rate conversion is switched to frame rate conversion for the M:N pulldown video signal.

9. A method for converting a frame rate, comprising:
a scroll detection step of detecting uniform scroll movement displayed across an entire screen from an input video signal;
a film footage detection step of detecting a M:N pulldown video signal from the input video signal, M and N being integers; and
a frame rate conversion step of performing frame rate conversion,
wherein, at the frame rate conversion step, if the uniform scroll movement across the entire screen is detected and a detection result obtained at the film footage detection step indicates that the M:N pulldown video signal is detected, the frame rate conversion is switched to frame rate conversion for the M:N pulldown video signal.

10. A method for converting a frame rate, comprising:
a film footage detection step of detecting a M:N pulldown video signal from an input video signal, M and N being integers;
a scroll detection step of detecting uniform scroll movement displayed across an entire screen from the input video signal; and
a frame rate conversion step of performing frame rate conversion,
wherein, at the frame rate conversion step,
if a detection result obtained at the film footage detection step indicates that the M:N pulldown video signal is detected and the uniform scroll movement across the entire screen is detected, the frame rate conversion is switched to frame rate conversion for the M:N pulldown video signal, and
if the detection result indicates that the M:N pulldown video signal is detected and the uniform scroll movement across the entire screen is not detected, the frame rate conversion is switched to frame rate conversion for an X:Y pulldown video signal having a smaller integer ratio than M:N.
